(19) United States
(12) Patent Application Publication
(10) Pub. No.: US 2006/0031780 A1
(43) Pub. Date: Feb. 9, 2006

(54) Dynamically configurable, task oriented communication between user and application

(76) Inventors: Ed Owen Schlotzhauer, Loveland, CO (US); Stacy Diane Schaut, Loveland, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/912,384

(22) Filed: Aug. 5, 2004

(51) Int. Cl. G06F 17/00

(52) U.S. Cl. 715/805

(57) ABSTRACT

A method for enabling communication between a user and an application. A window which enables communication between the user and the application is created within a graphical user interface. At least one task indicator is created dynamically from a data file within the window. Each created task indicator has a task associated with it. If one created task indicator is selected, the task associated with the selected task indicator is activated.

### BACKGROUND

In modern Test and Measurement systems, as well as other systems, a computer running one or more software applications which typically have a graphical user interface (GUI) is used to control various instrument functions. A help package for the application is generally included with the test and measurement applications and other applications with this help package consisting of a set of static pages contained in an on-line book or document that is launched from within the application. Context-sensitive help is accomplished by permitting the user to request help on a single item from within the application and automatically opening to a context appropriate page within the help document. In order to obtain help on a current task, the user must leave the context of the current work area to browse the help package for information regarding the current or other task. The ease of finding the correct information within the help package is dependant upon the organization and search capabilities within the on-line help. Information within the help package tends to be organized by product feature. As such, in order to locate information on a particular item, the user usually needs to understand the organization of the application. In this respect, the user typically creates within his mind two categories of knowledge for the application, the “application” area from which the application is initiated, controlled, and terminated, and the “help” area within which the user learns how to initiate, control, and terminate the application. Because most users are focused on performing the work at hand, they generally avoid activating the help area of the product until they are brought to a dead-end or are frustrated enough to try a new approach. Moving to the help is considered an interruption in completing their work and results in a less satisfying and less productive user experience.

An added complication is that information in the help package must be completed by the time the application is released to production. However, many applications can be extended at runtime by means of a “plug-in” technology. Help information, on the other hand, has not been dynamically extendable as has been the application itself via the plugin. Any help information for a plug-in has been provided in its own isolated help information package.

In addition, the help information has consisted only of text and/or pictures. The help information can describe what the user might do to accomplish certain tasks, but it cannot assist the user in doing it.

### SUMMARY

In representative embodiments, a method for enabling communication between a user and an application is disclosed. A window which enables communication between the user and the application is created within a graphical user interface. At least one task indicator is created dynamically from a data file within the window. Each created task indicator has a task associated with it. If one created task indicator is selected, the task associated with the selected task indicator is activated.

In an alternative representative embodiment, at least one information indicator is also created dynamically from the data file within the window. For each created information indicator, an information item associated with that information indicator is constructed dynamically from the data file. If one of the information indicators is selected, the contents of the information item associated with the selected indicator is displayed in the window.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1A is a drawing of a system with an application that has a task oriented, dynamically configurable help module, as described in various representative embodiments.

FIG. 1B is a drawing of a help module, as described in various representative embodiments.

FIG. 2 is a drawing of a graphical user interface (GUI) as described in various representative embodiments.

FIG. 3 is a flow chart of a method for creating the task oriented, dynamically configurable informational help module as described in various representative embodiments.

### DETAILED DESCRIPTION

As shown in the drawings for purposes of illustration, novel techniques are disclosed for providing related informational help to a user of a computer application. Previous informational help packages have typically consisted of a set of static pages contained in an on-line book or document that is launched from within the application. A main menu is used to display all the possible actions that could be performed by or to the application. In order to obtain help on a current task, the user must leave the context of the current work area to browse the help package for information regarding the current or other task.

As information within the help package tends to be organized byproduct feature, it is necessary for the user to become familiar with fairly detailed information prior to seeking help. In other words, the user must have fairly substantial knowledge before he can obtain help. This is at best an inefficient use of the user's time.

Since the user needs to leave the working area of the application, there is a strong tendency for user's to avoid using the help packages. Most users are focused on performing the work at hand and generally avoid activating the help area of the product until they are brought to a dead-end or are frustrated enough to try a new approach. Moving to the help is considered an interruption in completing their work and results in a less satisfying and less productive user experience.

An added complication is that information in the help package must be completed by the time the application is released to production. New features added to the application as plug-in's then require separate help packages.

Such help packages can describe what the user might do to accomplish certain tasks, but it cannot assist the user in doing it.

In the following detailed description and in the several figures of the drawings, like elements are identified with like reference numerals.

In representative embodiments, informational help techniques are disclosed which group and organize the functions which an application is expected to perform into application specific test and measurement or other system centric “tasks” which match the user's mental model for the work to be accomplished. Because an application and its use can migrate over time, these embodiments add dynamic configuration of the tasks to allow new tasks to be added to the application.

In addition, these embodiments will tend to decrease user confusion and frustration while using the applications and associated informational help packages. The user can become more productive in a shorter amount of time and should feel successful, rather than frustrated, during use of the application.

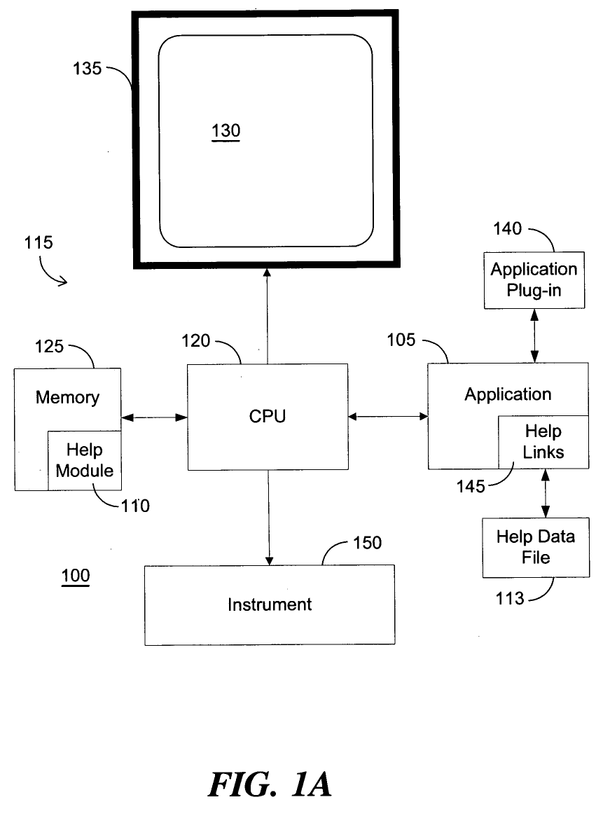

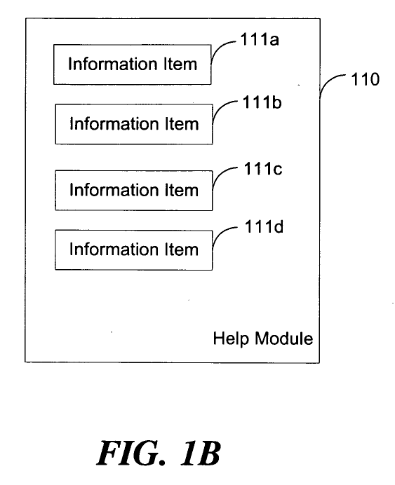

FIG. 1A is a drawing of a system 100 with an application 105 that has a task oriented, dynamically configurable help module 110, as described in various representative embodiments. In this representative example, the application 105 is operating on a computer 115 which additionally comprises a central processing unit (CPU) 120, a memory 125 within which the help module 110 is dynamically created and configured. The application 105 interacts with an instrument 150 via the CPU 120.

The computer 115 comprises the CPU 120, the memory 125, and a monitor 135 with its screen 130. In addition, the computer typically comprises the application 105 with its help links module 145, any associated application plug-in modules 140, and help module 110 which is typically created within the computer memory 125. Certain operations of the application 105 are visible on the screen 130 of the computer's monitor 135.

The help module 110 is created from the application 105 via help links module 145. Help links module 145 accesses help data file 113, also referred to herein as data file 113, at start-up of the application 105 to create help module 110 in computer memory 125 via interaction with the computer CPU 120. The functionality necessary to initiate creation of the help information in the help module 110 is coded into the help links module 145 of the application 105. The help data file 113 comprises data which is relatively easy to change as the application 105 evolves.

Additional application capabilities can be provided to the application 105 by the add-on module 140, also referred to herein as plug-in module 140 or alternatively as plug-in 140. The help module 110 is configurable via changes in the help data file 113 as plug-ins 140 are added to the application 105. In an alternative embodiment, the help module 110 is dynamically configurable as plug-ins 140 are added, deleted, and modified. This can be effected by recreating applicable portions of the help module 110 as they are accessed.

Help module 110 is more generally referred to as information module 110 as it could be used to provide a variety of information as needed at various stages in the operation of the application 105.

FIG. 1B is a drawing of the help module 110, as described in various representative embodiments. The help module 110 comprises a number of information items 111, four of which are indicated in FIG. 1B as information items 111a, 111b, 111c, 111d. The information items 111 each comprise human understandable contents which could be, for example, text and/or graphics.

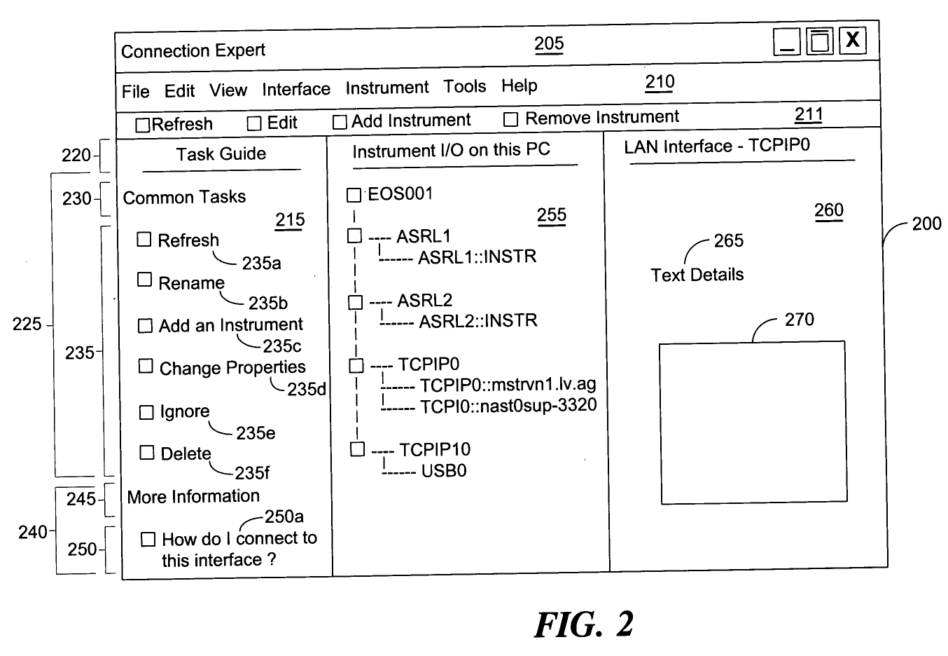

FIG. 2 is a drawing of a graphical user interface (GUI) 200 as described in various representative embodiments. The graphical user interface 200 of FIG. 2 comprises a title bar 205, a menu bar 210, and a tool bar 211 which are standard components of graphical user interfaces 200. A graphical user interface 200 is a software program (an application) interface which takes advantage of the graphics capabilities of a computer to provide a more user friendly means for using the program. Traditionally information about the program and information useful in using the program is provided via the tool bar 211 or the menu bar 210. As stated above, this technique of providing such information takes the user away from the functioning part of the program and is often avoided by the user except as a last resort.

In the representative embodiment of FIG. 2, the graphical user interface 200 comprises a task window 215, also referred to herein as a first window 215 and alternative as a window 215. The task window 215 comprises typically a task window label 220, also referred to herein as a first label 220, which in the example of FIG. 2 is labeled “Task Guide”, a task section 225, also known herein as a first section 225, and an information section 240, also known herein as a second section 240.

The task section 225 comprises typically a task section label 230, also known herein as a second label 230 which is labeled “Common Tasks” in FIG. 2, and at least one task indicator 235, also referred to herein as at least one first indicator 235, which are selectable and which if selected performed tasks defined by the application 105 from the task window 215. Task indicators 235 shown in FIG. 2 are as follows: first task indicator 235a labeled as “Refresh”, second task indicator 235b labeled as “Rename”, third task indicator 235c labeled as “Add an Instrument”, fourth task indicator 235d labeled as “Change Properties”, fifth task indicator 235e labeled as “Ignore”, and sixth task indicator 235f labeled as “Delete”. The various identified numbered first, . . . , sixth task indicators 235a, . . . , 235f of FIG. 2, and others as needed, are collectively referred to as task indicators 235.

The information section 240 comprises typically an information section label 245, also referred to herein as a third label 245, which is labeled as “More Information” in FIG. 2, and at least one information indicator 250, also referred to herein as at least one second indicator 250, which are selectable and which if selected provide information which can be sensitive to the context of the task window 215 and which, in representative embodiments, is dynamically configurable. For illustrative purposes, only one information indicator 250, first information indicator 250a labeled as “How do I connect to this interface?”, is shown in FIG. 2. Additional information indicators 250, for example a second information indicator 250b, could be included as needed and are collectively referred to as information indicators 250.

The window in the lower middle of the graphical user interface 200 is an optional second window 255 which could include various items related to the application 105. In the representative example of FIG. 2, the second window 255 comprises a hierarchical tree structure which indicates the steps to be performed for connecting and configuring various types of hardware interconnections.

The window in the lower right of the graphical user interface 200 is an optional third window 260 which could include various items related to the application 105. In the representative example of FIG. 2, the third window 260 comprises text 265 and drawings or pictures 270 which may include a description and pictures of the instrument 150 interconnections as related to the particular task window 215 displayed.

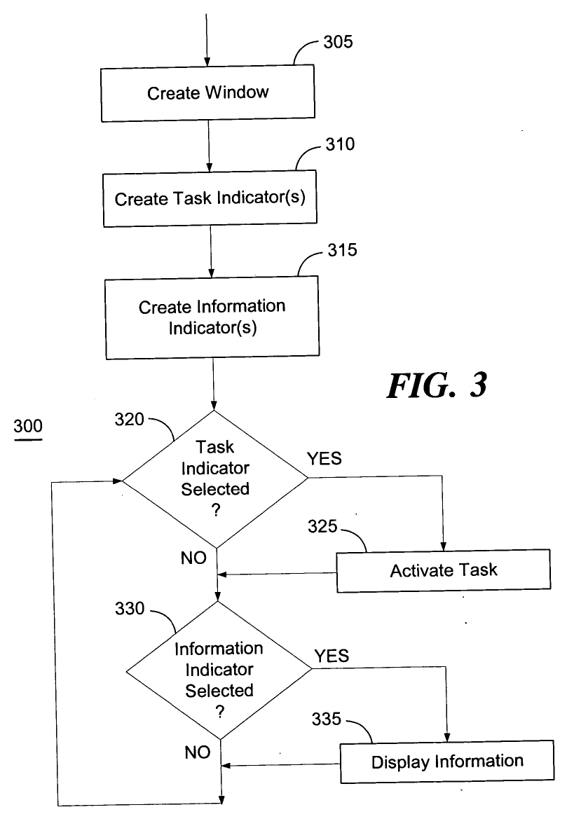

FIG. 3 is a flow chart of a method 300 for creating the task oriented, dynamically configurable informational help module 110 as described in various representative embodiments. In block 305 of FIG. 3, the task window 215 is created within the graphical user interface 200. The task window 215 enables communication between a user and the application 105. Block 305 then transfers control to block 310.

In block 310, at least one task indicator 235 is created within the task window 215. Each of the at least one task indicators 235 has a task associated with it. Block 310 then transfers control to block 315.

In block 315, at least one information indicator 250 is created within the task window 215. Block 315 then transfers control to block 320.

In block 320, if one of the at least one task indicators 235 is selected, block 320 transfers control to block 325. Otherwise, block 320 transfers control to block 330.

In block 325, the task associated with the selected at least one task indicator 235 is activated. Block 325 then transfers control to block 330.

In block 330, if one of the at least one information indicators 250 is selected, block 330 transfers control to block 335. Otherwise, block 330 transfers control to block 320 which provides continual monitoring of user selection.

In block 335, information associated with at least one of the at least one information indicators 250 in the task window 215 is displayed. The information displayed is dynamically configurable. In a representative embodiment, the information displayed is typically related to at least one of the tasks. Block 335 then transfers control to block 320 which as stated above provides continual monitoring of user selection.

In representative embodiments, dynamically configurable, context aware, task oriented guidance is a part of the graphical user interface 200 displayed on the screen 130 of the computer 115 monitor 135. With this technique, the user will not consider the guidance information as help, but rather as an integral part of the application 105. Instead of a static application 105 which provides a menu driven list of all the things that the user could do in the application 105, a new region of the graphical user interface 200 integrates both help and the application 105 by emphasizing tasks.

This new help and application 105 integrated area presents to the user a possible list of tasks that they are most likely to perform based on the current context of the application 105. Clicking a mouse on the option within the task area (the task window 215) can bring up an on-line document explaining a concept, may actually initiate the action within the graphical user interface 200 that the user is using to control the application 105, or may initiate a sequence of dialog boxes often called a “Wizard” to guide the user through a series of steps to accomplish the desired task or the task window 215 may dynamically change to guide the user through Wizard-like sequences of actions. As the user navigates and selects tasks, the task window 215 modifies and selects new options based on the current task or context.

This task window 215 becomes the user's control center while also educating the user on things that can be accomplished by the application 105, as well as how these tasks can be accomplished. The tasks presented to the user should be relevant to the application's current context to be most affective.

As an application 105 evolves, or new uses of the application 105 are implemented, the task windows 215 presented to the user in the application 105 can be updated to track these changes. Updating can be accomplished by recreating the help module 110 from the help data file 113 at application 105 start-up. Further, the help module 110 can be dynamically configured without shutting the application 105 down which results in the dynamic configuration of the task windows 215. Among other techniques, dynamic configuration can be effected by recreating applicable portions of the help module 110 as they are accessed. Dynamic configuration also permits the task oriented help information to be extended via plug-in modules 140 that not only add new functionality but also provide task-oriented guidance specific to the capabilities of the plug-in modules 140.

The help data file 113 could be, for example, an extensible markup file (XML). And, the help module 110 (as well as any dynamically created associations or links between information indicators 250, task indicators 235, and associated tasks) could be, for example, created in computer random access memory (RAM).

As is the case, in many data-processing products, the systems described above may be implemented as a combination of hardware and software components. Moreover, the functionality required for use of the representative embodiments may be embodied in computer-readable media (such as floppy disks, conventional hard disks, DVD's, CD-ROM's, Flash ROM's, nonvolatile ROM, and RAM) to be used in programming an information-processing apparatus (e.g., the computer 115 comprising the elements shown in FIG. 1A among others) to perform in accordance with the techniques so described.

The term “program storage medium” is broadly defined herein to include any kind of computer memory such as, but not limited to, floppy disks, conventional hard disks, DVD's, CD-ROM's, Flash ROM's, nonvolatile ROM, and RAM.

The computer 115 can be capable of running one or more of any commercially available operating system such as DOS, various versions of Microsoft Windows (Windows 95, 98, Me, 2000, NT, XP, or the like), Apple's MAC OS X, UNIX, Linux, or other suitable operating system.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method for enabling communication between a user and an application, comprising:
creating a window within a graphical user interface, wherein the window enables communication between the user and the application;
creating dynamically from a data file at least one task indicator within the window, wherein each created task indicator has a task associated with it; and
if one created task indicator is selected, activating the task associated with the selected task indicator.

2. The method as recited in claim 1, wherein association between at least one created task indicator and its associated task is created dynamically in random access memory (RAM) of a computer.

3. The method as recited in claim 1, wherein the data file is an extensible markup file (XML).

4. The method as recited in claim 1, wherein the application communicates with an instrument.

5. The method as recited in claim 1, further comprising:
if one created task indicator is selected,
creating new window within the graphical user interface, wherein the window enables communication between a user and the application;
replacing the original window with the new window;
creating at least one new task indicator within the new window, wherein each of the at least one new task indicators has a task associated with it; and
if one created new task indicator is selected, activating the task associated with the selected new task indicator.

6. The method as recited in claim 1, further comprising:
creating dynamically from the data file at least one information indicator within the window;
for each created information indicator, constructing dynamically from the data file an information item associated with that information indicator; and
if one of the information indicators is selected, displaying the contents of the information item associated with the selected indicator in the window.

7. The method as recited in claim 6, wherein contents of the information item displayed by the instruction displaying information is related to at least one of the task indicators.

8. The method as recited in claim 6, wherein at least one of the information items is created in random access memory (RAM) of a computer.

9. The method as recited in claim 6, wherein the data file is an extensible markup file (XML).

10. The method as recited in claim 6, wherein the contents of the at least one information item is related to the state of the application as indicated by the window.

11. The method as recited in claim 6, wherein the application communicates with an instrument.

12. The method as recited in claim 6, further comprising:
if one created task indicator is selected,
creating new window within the graphical user interface, wherein the window enables communication between a user and the application;
replacing the original window with the new window;
creating at least one new task indicator within the new window, wherein each of the at least one new task indicators has a task associated with it; and
if one created new task indicator is selected, activating the task associated with the selected new task indicator.

13. The method as recited in claim 12, further comprising:
if one created task indicator is selected,
creating dynamically from the data file at least one new information indicator within the new window;
for each created new information indicator, constructing dynamically from the data file new information item associated with that new information indicator; and
if one of the new information indicators is selected, displaying the contents of the new information item associated with the selected new indicator in the new window.

14. A computer readable memory device embodying a computer program of instructions executable by a computer, the instructions comprising:
creating a window within a graphical user interface, wherein the window enables communication between a user and an application;
creating dynamically from a data file at least one task indicator within the window, wherein each created task indicator has a task associated with it; and
if one created task indicator is selected, activating the task associated with the selected task indicator.

15. The computer readable memory device as recited in claim 14, wherein association between at least one created task indicator and its associated task is created dynamically in random access memory (RAM) of the computer.

16. The computer readable memory device as recited in claim 14, wherein the data file is an extensible markup file (XML).

17. The computer readable memory device as recited in claim 14, wherein the application communicates with an instrument.

18. The computer readable memory device as recited in claim 14, the instructions further comprising:
if one created task indicator is selected,
creating new window within the graphical user interface, wherein the window enables communication between a user and the application;
replacing the original window with the new window;
creating at least one new task indicator within the new window, wherein each of the at least one new task indicators has a task associated with it; and
if one created new task indicator is selected, activating the task associated with the selected new task indicator.

19. The computer readable memory device as recited in claim 14, the instructions further comprising:
creating dynamically from the data file at least one information indicator within the window;
for each created information indicator, constructing dynamically from the data file an information item associated with that information indicator; and
if one of the information indicators is selected, displaying the contents of the information item associated with the selected indicator in the window.

20. The computer readable memory device as recited in claim 19, wherein contents of the information item displayed by the instruction displaying information is related to at least one of the task indicators.

21. The computer readable memory device as recited in claim 19, wherein at least one of the information items is created in random access memory (RAM) of the computer.

22. The computer readable memory device as recited in claim 19, wherein the data file is an extensible markup file (XML).

23. The computer readable memory device as recited in claim 19, wherein the contents of the at least one information item is related to the state of the application as indicated by the window.

24. The computer readable memory device as recited in claim 19, wherein the application communicates with an instrument.

25. The computer readable memory device as recited in claim 19, the instructions further comprising:
if one created task indicator is selected,
creating new window within the graphical user interface, wherein the window enables communication between a user and the application;
replacing the original window with the new window;
creating at least one new task indicator within the new window, wherein each of the at least one new task indicators has a task associated with it; and
if one created new task indicator is selected, activating the task associated with the selected new task indicator.

26. The computer readable memory device as recited in claim 25, the instructions further comprising:
if one created task indicator is selected,
creating dynamically from the data file at least one new information indicator within the new window;
for each created new information indicator, constructing dynamically from the data file new information item associated with that new information indicator; and
if one of the new information indicators is selected, displaying the contents of the new information item associated with the selected new indicator in the new window.
